(19) United States
(12) Patent Application Publication
(10) Pub. No.: US 2004/0194507 A1
(43) Pub. Date: Oct. 7, 2004

(54) Coated optical components

(76) Inventors: Michael Richard Harris, Worcestershire (GB); Keith Loder Lewis, Worcestershire (GB); Paul David Mason, Worcestershire (GB); Euan James McBreaty, Worcestershire (GB); David Arthur Orchard, Worcestershire (GB)

Correspondence Address: MCDONNELL BOEHNEN HULBERT & BERGHOFF LLP, 300 S. WACKER DRIVE, 32ND FLOOR, CHICAGO, IL, 60606, US

(21) Appl. No.: 10/490,801

(22) PCT Filed: Oct. 2, 2002
(86) PCT No.: PCT/GB02/04481

(30) Foreign Application Priority Data
Oct. 3, 2001 (GB) 0123744.5

(51) Int. Cl. C03C 27/00; C03C 17/02; C03C 3/32; C03C 19/00; G02B 1/10; G02B 1/02; C03C 23/00; C03C 27/06

(52) U.S. Cl. 65/31; 428/410; 427/162; 264/1.21; 264/1.7; 264/2.7; 65/43; 65/44; 65/102

(57) ABSTRACT

An optical substrate is provided with a surface of a desired shape by coating the surface with a thin layer of an optical glass and subsequently modifying the shape of the external surface of the layer. In preferred embodiments, the temperature of the substrate is maintained at substantially less than 400° C., the substrate is an optical component other than a simple window, and the refractive index o the optical glass is within 20% of the refractive index of the material providing the surface to be coated. One particular use is when both the substrate (e.g. a non-linear optical layer) and the optical glass are optically transmissive in the near infra-red and/or mid infra-red ranges. The glass layer can compensate for physical imperfections in the surface. It can be polished to optical quality, or provide with detail across the coated surface, e.g. as a “moth-eye” anti-reflection layer, or a diffractive or interference structure.

The present invention relates to the provision of a glass coating with a shaped exterior surface on an optical substrate, and to coated substrates so formed. It relates particularly but not exclusively to the provision of coatings which are so shaped as to have anti-reflection properties.

It is commonplace to coat at least one surface of an optical substrate, whether a simple component or a more complex device, with an antireflection coating comprising one or more superimposed dielectric layers using standard coating methods, and techniques for so doing been described and demonstrated elsewhere. The dielectric layers have a substantially uniform thickness and its properties are determined by the materials of the dielectric layers and their thicknesses and ordering (if more than one layer).

However with optical substrates in the form of crystals that are difficult to polish, such as ZnGeP₂, it can be very difficult to apply such coatings using conventional dielectric coating methods. Either the coatings do not adhere to the surfaces or else they are physically unstable, especially in the presence of intense optical fields such as those from a laser source.

One relatively new such technique involves the application of a sub-wavelength periodic structure to the surface of the substrate, often referred to as “moth-eye” coating—see, for example, D H Raguin and G M Morris, “Structured surfaces mimic coating performance”, Laser Focus World, p113, April 1997. The structure introduces a continuous refractive index distribution between that of the ambient environment (e.g. air) and the bulk substrate material. The precise design of the structure can be chosen to act as an antireflection coating covering a broad spectral range.

Moth-eye structures are usually applied using a metal mask created by photo-lithographic techniques. This is either used as a mask for direct etching of the bulk substrate material or for embossing the surface of the substrate, usually under pressure. The latter method in particular requires a substrate material providing a surface that is sufficiently soft to deform to the mask without affecting the underlying substrate. However, irrespective of which method is used, there are some substrate materials such as ZnGeP₂ where the preliminary preparation to give a satisfactory surface is difficult or impossible. Similar considerations apply where the shaping is applied for some other purpose, for example to form an interference structure such as a Fresnel lens or a diffractive structure, e.g. a diffraction grating, on the optical substrate.

It has been found that the various problems outlined above can be alleviated by depositing a layer of an optical glass onto the surface of the optical substrate and subsequently shaping the glass layer, for example by embossing under pressure, or by etching. Thus if the layer of glass is so provided with a sub-wavelength periodic structure as in a “moth-eye” structure, it can behave as an antireflection coating.

During this process the glass layer can compensate for defects in the surface of the optical substrate, thus minimising the surface preparation requirements thereof. During deposition and or the further shaping process the glass can fill or surround any defects or contamination on the substrate surface to provide an efficient optical interface thereto, particularly if it is closely index matched to the material of the substrate surface.

The invention provides a method of providing an optical substrate with a surface having a desired shape, the method comprising the steps of coating the surface with a thin layer of an optical glass, and subsequently modifying the shape of the external surface of the layer. More than one surface, e.g. both opposed surfaces of a generally laminar substrate may be so coated.

It is known to coat a surface of a substrate with a glass layer and subsequently to shape the external surface of the glass layer. For example, GB Patent Application No. 2 168 340 (STC) discloses the coating of an integrated surface with a glass layer which is subsequently planarised by pulse heating; and GB Patent Application No. 2 146 566 (Standard Telephones and Cables) similarly discloses the coating of a silicon body (e.g. a transducer) with a glass layer which is ground and polished prior to electrostatic bonding to a substrate. In both cases the glass layer is used for its electrically insulating properties; whether or not it, or the substrate, is of optical quality is irrelevant.

European Patent Application No. 697 377 (Honjo Sorex) discloses the production of a patterned thin NESA glass membrane electrode on a glass substrate for use in plasma and liquid crystal displays. As described therein, the temperature of the glass substrate needs to be not less than 400° C., e.g. 480-520° C. By contrast, in the present invention, the temperature of the substrate is preferably maintained substantially lower than 400° C. more preferably lower than 350° C. and even more preferably lower than 300° C. by an appropriate choice of materials and processing conditions.

Similarly, JP05 246727 (Nakazawa Masataka) describes the production of a glass waveguide on which is coated a higher refractive index coating containing a rare earth element, where the coating is obtained by deposition from a solution followed by heating to 1200-1300° C., after which it is masked and etched. JP55-062823 (Fujitsu) describes the preparation of a high quality electrode-forming surface of a glass substrate, e.g. for a discharge panel, in which low melting point glass is screen printed and then calcined at 550-600° C., but in this case it is not apparent that the glass layer itself is subsequently shaped.

Furthermore, in Honjo and Fujitsu the substrate is necessarily optically transmissive, but it performs no other function than acting as a window. In Nakazawa, there is necessarily a refractive index difference between the substrate and glass layer. In preferred embodiments of the present invention the substrate performs some additional optical function, for example as a non-linear optical layer, a lens, or mirror, and/or there is substantially no refractive index difference, or that difference is minimised, by suitable choice of materials.

If appropriate, the external surface of the glass layer can be polished to optical standards to remove the effect of any underlying surface defects. This could provide the shape modifying step of the method according to the invention, and is advantageous since per se it will provide an optical quality surface on materials which are difficult to process in themselves. In such a case the final shape of the external coating surface will substantially conform to the general shape of the underlying substrate surface. Since the substrate surface to be coated may be planar or may itself have a non-planar shape as in a concave or convex lens or mirror, this will be substantially replicated by the external surface of the optical glass layer, but with an improved optical quality.

In other applications of the method of the invention, the shape modifying step may provide detail on a smaller scale, for example to provide a “moth-eye” antireflection coating, or other diffraction structure or grating, or a Fresnel lens. It may or may not include the preliminary optical quality polishing step mentioned above, depending on the surface quality, inter alia.

The shape modifying step may be effected by any known technique, such as by etching or embossing. In a preferred method, the optical glass has at least a first glass transition temperature Tg, and a higher devitrification temperature Tc, and the shaping is performed by embossing at a temperature Te between Tg and Tc.

Preferably an appropriate metal mask is used for the embossing or etching steps.

The choice of optical glass will be determined by a number of considerations, including compatibility with the intended use of the substrate (for example transmissive in the appropriate wavelength range, including the visible and infrared), and the need to process it by a method according to the invention. In preferred embodiments the glass may be a chalcogenide glass. Chalcogenide glasses have a number of advantageous properties, including relatively low melting and softening points (so that they can be used on thermally sensitive substrates), relatively good transmissivity in the near and mid infra-red ranges (so that they can be used on substrates selected for their near and/or mid infra-red properties), and a range of refractive indices suitable for providing an exact or near index match to a number of useful optical substrate materials, including such materials which are useful in the near and/or mid infra-red, such as silicon and gallium arsenide.

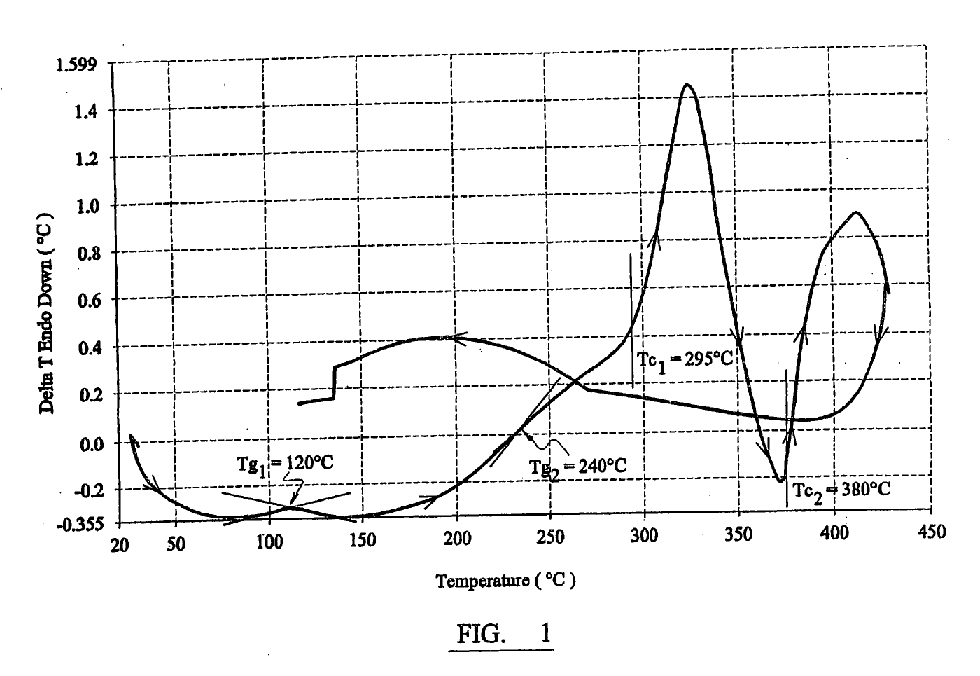

FIGS. 1 to 3 show differential thermal analysis plots for chalcogenide glasses having three different compositions.

In addition to a glass devitrification temperature Tc, corresponding to a change from a glassy phase to a melt phase or a crystalline phase or to decomposition, many glasses have at least one glass transition temperature Tg where a glassy phase is retained but with somewhat different properties. In particular, heating the glass through a temperature Tg to obtain a higher temperature glassy phase (the reader will appreciate that the phase change may require other conditions, and in particular the phase change may take a significant time) can provide a phase which is appreciably softer or more mobile.

Glass phase transitions may be detected by differential thermal analysis, wherein heat is supplied at a controlled rate to a sample and the temperature of the sample is plotted over time. During differential thermal analysis the temperature initially follows a generally linear plot, and phase transitions are indicated by deviations from linearity. In particular a glass transition temperature Tg may be identified by a discontinuity in the plot, generally in the form of a knee. Further transition points may be identified at higher temperatures, and at least one of these may correspond to the devitrification temperature. The latter may be identified since upon performing the reverse measurement by cooling the sample the corresponding knee is absent or at least does not occur at the same temperature.

FIG. 1 shows a differential thermal analysis plot for the material Ge₁₅As₁₅Se₂₉Te₄₁, using the following cycle:

1. Hold at 20.00° C. for 1.0 minutes

2. Heat from 20.00° C. to 450.00° C. at 10.00° C./minute

3. Hold for 10.0 minutes at 450.00° C.

4. Cool from 450.00° C. to 20.00° C. at 10.00° C./minute

Two inflection points on the rising part of the curve at 120° C. and 240° C. are respective first and second glass (glass/glass) transition temperatures Tg1 and Tg2. Steeper transitions Tc1 and Tc2 at 290° C. and 380° C. are transitions associated with crystal phases, and the lower of these temperatures, Tc1, will be the devitrification temperature since at that point the material ceases to be in a glassy phase. In FIG. 1 it will be observed that the curve is not retraced upon cooling, shows no (reverse) glass/glass transition points corresponding to Tg1 and Tg2, and does not return to the starting point. Thus any thermal processing of this material is likely to be associated with marked changes in the properties of the material, and these changes may be dependent on a number of factors (e.g. times, temperatures, heating rates, atmospheres) so that any change may well be difficult to reproduce reliably.

As used herein, “first glass transition temperature” refers to the lowest glass transition temperature above ambient.

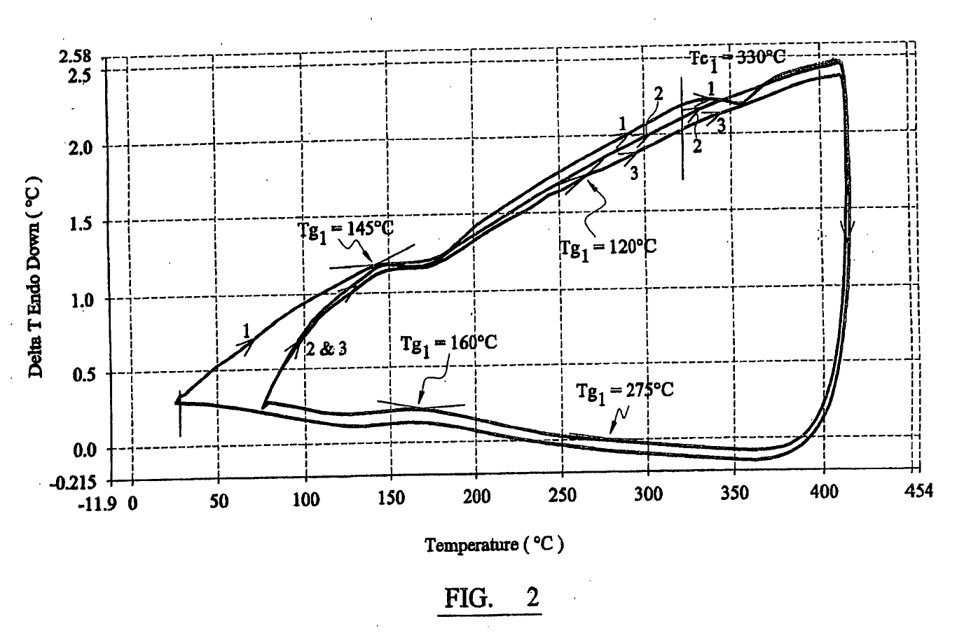

FIG. 2 shows a differential thermal analysis plot for the material Ge₁₅As₁₅Se₁₇Te₅₃ using the following cycle:

1. Hold for 1.0 minute at 20.00° C.

2. Heat from 20.00° C. to 440.00° C. at 10.00° C./minute

3. Cool from 440.00° C. to 80.00° C. at 10.00° C./minute

4. Hold for 20.0 minutes at 80.00° C.

5. Heat from 80.00° C. to 440.00° C. at 10.00° C./minute

6. Cool from 440.00° C. to 80.00° C. at 10.00° C./minute

7. Hold for 20.0 minutes at 80.00° C.

8. Heat from 80.00° C. to 440.00° C. at 10.00° C./minute

9. Cool from 440.00° C. to 20.00° C. at 10.00° C./minute

10. Hold for 60.0 minutes at 20.00° C.

Compared with FIG. 1 this plot is a relatively simple trace involving first and second glass (glass/glass) transition temperatures Tg1 and Tg2 at 145° C. and 260° C., and a single devitrification temperature Tc1 330° C. On cooling, while the curve is not retraced, reverse glass transition points Tg1 and Tg2 at 275° C. and 160° C. are exhibited. The trace is repeatable, as evidenced by measurements over three cycles with heating to 330° C.

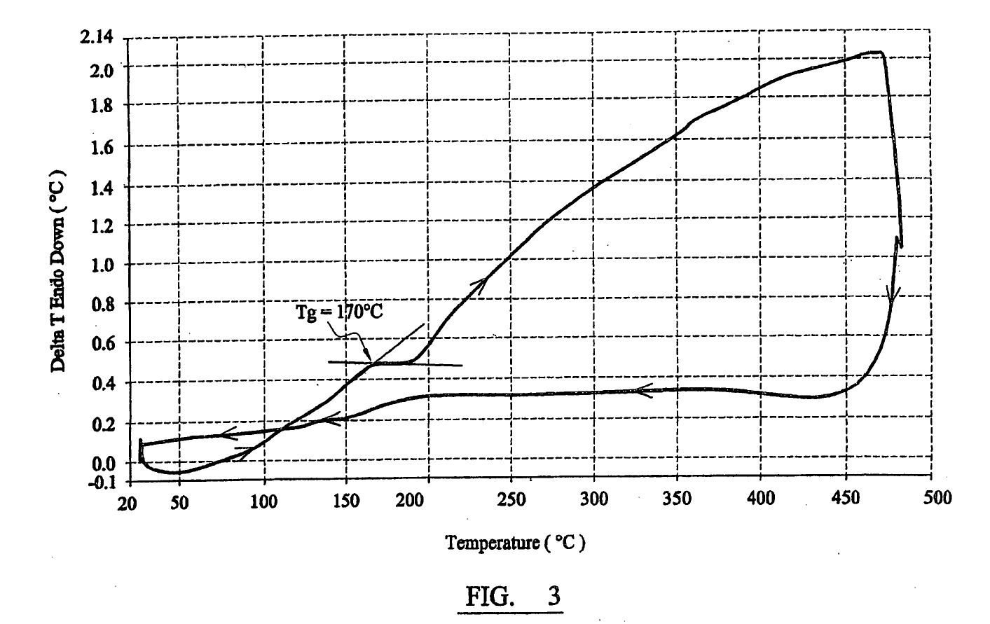

FIG. 3 shows a differential thermal analysis plot for the material Ge₁₉As₁₁Se₁₇Te₅₃, using the following cycle:

1. Hold at 20.00° C. for 1.0 minutes

2. Heat from 20.00° C. to 500.00° C. at 10.00° C./minute

3. Hold for 10.0 minutes at 500.00° C.

4. Cool from 500.00° C. to 20.00° C. at 10.00° C./minute.

5. Hold for 60.0 minutes at 20.00° C.

This plot is even simpler than that of FIG. 2, showing just a single glass/glass transition temperature Tg at 170° C., and no devitrification point up to a temperature in excess of 470° C. There is a large temperature interval between Tg and the highest temperature investigated.

The conditions under which the method of the invention is effected, including the choice of the coating optical glass material, the manner of deposition of the thin glass layer, and Te (or the temperature-time profile) where embossing is employed, are preferably selected so that there is no undesired change in the substrate which is coated, for example by destroying or distorting it or its surface, or producing an irreversible phase change therein. In most cases the ideal is that the substrate is substantially wholly unaffected by the whole process, or at least that subsequent to the whole process it corresponds substantially to the starting substrate even if some form of (reversible) change has occurred in the meantime. However, it is envisaged that there may be occasions when Te is selected to cause a desired change such as an irreversible phase in the material of the substrate so as to produce modified but desired properties therein.

Where the optical glass exhibits a plurality of glass transition temperatures above ambient, Te is preferably selected to lie between the first and second glass transition temperatures.

The optical glass coating may be deposited by any known technique, including RF sputtering, flash evaporation, solvent evaporation or spin coating.

In particular embodiments the optical glass may comprise Ge, As, Se and Te, and one range of preferred glasses has the general formula Ge₍ₓ₋ₐ₎AsₐSe_{(100-x-b)}Te_{b} where 25<x≦55 (preferably 25<x≦40); 10≦a≦25; 40<b≦70, and (100-x-b)>0 (see our copending UK Patent Application No. GB 0123743.7). Useful compositions Ge₁₅As₂₅Se₁₄Te₄₆, Ge₂₀As₂₀Se₁₄Te₄₆, and Ge₁₅As₁₅Se₅Te₆₅, and the glasses of FIGS. 1 to 3 conform to this formula. More preferably, particularly for example where the substrate is of GaAs or silicon, 30≦x≦40; and 50<b≦70. In these ranges there exist glasses having good to very good thermal characteristics with indices closely matching those of GaAs, silicon and ZnGeP₂.

Alternatively the coating optical glass may be amorphous arsenic sulphide.

Preferably the optical glass is selected such that it undergoes the shaping or embossing cycle reversibly, so that its properties at the end of the cycle, i.e. on reverting to ambient conditions, are substantially identical to those at the commencement of the cycle. The glass of FIG. 1 does not conform to this criterion and so is not a preferred material. The glasses of FIGS. 2 and 3 are preferred materials according to this criterion. In a less preferred alternative, the processing of the glass layer subsequent to deposition, for example the use of heating and pressure during embossing, may be selected such that the glass layer undergoes an effectively irreversible change, for example a phase change, which gives desirable properties (for example, a change in refractive index more closely matched to the substrate).

Preferably the optical glass has only one glass transition temperature before the devitrification temperature is reached, making the glass of FIG. 3 more preferable than that of FIG. 2.

Preferably there is an interval of at least 50° C., more preferably at least 100° C., and even more preferably at least 150° C., between the (first) glass transition temperature and any other transition temperature, whether a further glass transition temperature or the devitrification temperature. On this criterion the glass of FIG. 3 is again more preferable to that of FIG. 2, although both conform to the wider criteria.

The refractive index of the coating optical glass is preferably close to, and ideally equal to, that of the surface on which it is coated. This reduces undesired reflections at the surface which is coated. Thus, the optical glass has a refractive index which is preferably within 20% of the refractive index R of the material providing the surface to be coated (i.e. R+/−20%), more preferably within 15% and even more preferably within 10%, and most preferably within 5%.

Infrared transmitting chalcogenide glasses based on the Ge—As—Se—Te system have been prepared with refractive indices in the range n=3.00 to 3.45. These glasses have also been successfully coated onto silicon (n=3.43) and GaAs (n=3.28) substrates, with layer thicknesses of from 0.1 microns and upwards, using a RF sputtering technique.

The optical glass coating may thereafter be embossed with a metal mask to produce a “moth-eye” antireflection coating.

This method of providing an AR coating can be applied by itself, or in conjunction with the optical joining techniques of the invention described above in relation to the first aspect and also in the embodiments and claims below.

The thickness of the optical glass coating is preferably between 3 and 40 microns, more preferably between 4 and 30 microns and still more preferably between 5 and 20 microns.

The surface which is coated may be of substantially monocrystalline material.

The surface to be coated may be planar or it may itself have a non-planar shape, for example curved in one or both dimensions, as in a concave or convex lens or mirror, which will be substantially replicated by the external surface of the optical glass layer. This external shape of the optical glass coating is, of course, further modified by the shaping step of the method of the invention.

The shaping may be such as to provide a surface profile in the form of a “moth-eye” structure, having anti-reflection properties. The broad-band nature of the moth-eye coating is ideally suited for optical crystals that will be used for multi-spectral applications. These include non-linear optical crystals, such as ZnGeP₂ (n=3.1), used in near-IR pumped optical parametric oscillators, and in other non-linear devices operating in the near and/or mid-infrared. However, as indicated above, the shaping may be for other purposes such as the provision of a diffracting structure or a Fresnel lens.

The optical substrate treated by a method according to the invention may be a simple passive monolithic optical component per se, such as a lens or prism, or, it may be part of a more complex optical arrangement, such as a layer provided to resist optical radiation damage. It may alternatively be, or be part of, an optically or electrically active component or device such as a light source, detector or a component or device comprising non-linear or lasing material, for example an electro-optic semiconductor device such as a LED or photodiode, or a parametric device, or a semiconductor or other laser. A relatively simple example is the application of a “moth-eye” antireflection coating to a prism coupled to some other optical component.

A more complicated example is the application of “moth-eye” antireflection coatings to a stack or sequence of spaced optical components, e.g. lenses, prisms or non-linear optical layers, where the coating may be applied to only one surface of each component but is preferably applied to both surfaces.

Non-linear optical materials are useful for the production of new wavelengths via conversion of existing laser wavelengths (e.g. M Fejer, Physics Today, May 1994)). Common applications of non-linear optical materials include frequency-doubling and optical parametric oscillators. In such devices, fundamental (input) and generated (output) optical waves propagate together through the material and energy is transferred from the fundamental to the generated waves (forward-conversion). The reverse process, in which energy is transferred from the generated waves to the fundamental wave(s), can also occur. This is known as back-conversion.

The direction and efficiency of the non-linear process is determined by the phase relationship between the various interacting waves. In general, the phase relationship changes as the waves propagate through the non-linear optical material, resulting in alternating sections of forward- and back-conversion. The maximum useful length of material is the length of one such section and is known as the coherence length for the material. This is the distance over which the interacting waves retain a suitable phase relationship for forward conversion. If the waves propagate beyond this distance, energy is transferred back from the generated waves to the fundamental wave. In general, the coherence length is too short to be useful unless a technique known as phase-matching can be employed.

The most common form of phase matching requires non-linear optical materials that are birefringent crystals. The direction of propagation and polarisation of the various waves is chosen so that a suitable phase relationship for forward conversion is maintained throughout the crystal and the coherence length is longer than the crystal. However, the phase-matching constraint defines the direction of propagation, which may not be the direction for which the non-linear interaction is strongest. Also, the various beams may ‘walk-off’ and become spatially separated within the crystal. It is not always possible to satisfy the phase-matching condition at all wavelengths for which the crystal is transparent. Furthermore, the number of non-linear materials suitable for use in parts of the infrared spectrum which are also birefringent is rather limited.

An alternative form of phase matching is known as quasi-phase matching. In this technique the non-linear optical material is divided into sections exactly one coherence length (or an odd multiple of coherence lengths) long, either by producing striated crystals during growth, or by appropriate poling of a crystal, or by assembly of multiple layers with different crystal orientations or polings. Within each section a useful non-linear optical interaction can occur as the waves get progressively out of phase. If the material axis is reversed in the following section then the interaction can continue. By reversing the axis in successive sections in this manner, an arbitrary interaction length can be achieved (J McMullen, J Appl Phys, vol 46 no7, p3076-3081). Quasi-phase matching allows the use of non-linear optical materials that cannot be phase-matched using birefringence. This is of particular importance in optical wavebands for which there are few good birefringent non-linear optical materials available.

Striated crystals and poled crystals tend to be useful only for low aperture devices, because of their manner of production. However, the assembly method has potential for providing larger aperture devices useful in high power applications where it is necessary to minimise the possibility of optical damage to the device, although a primary difficulty in assembling different sections into a stack structure lies in producing a quasi-phase matched structure of sufficient quality to be useful. There are major problems both in providing high quality optical coupling between adjacent sections, and in producing or maintaining accurate control of section lengths and distances between sections. These problems can be acute in this type of assembly, which typically comprises from tens to over a hundred non-linear layers.

Both problems can be reduced by use of the present invention, by covering at least some and preferably all faces of the non-linear optical layers with a “moth-eye” shaped glass antireflection layer. Not only is the layer broad-band, so that it can be effective at all wavelengths present in the stack, but it can also serve satisfactorily to cope with surface defects or contamination on the bare surfaces of the non-linear layers.

In fact, the moth-eye anti-reflection layer is regarded as being one of the best ways of achieving optical coupling between spaced layers. Preferably the insertion loss at each surface is no more than 0.5% per interfaces, more preferably no more than 0.3%, even more preferably no more than 0.2%, and most preferably no more than 0.1% (ideally substantially zero). Alternatively, the total insertion loss in the stack is preferably no more than 50%, more preferably no more than 20%, even more preferably no more than 10%, and most preferably no more than 5% (again ideally substantially zero). The stack may comprise more than 50 interfaces (25 non-linear layers), and possibly more than 100 or 200 interfaces.

Using this approach a quasi-phase matched stack of GaAs wafers designed to produce output wavelengths in the 3-5 μm band from a pump wavelength around 21 μm is constructed by simply assembling a stack of suitably coated wafers separated by small air gaps. Bonding of the layers is not necessary since the reflection losses have become very small.

Our copending UK Patent Application No. GB 0123731.2 relates to a method of joining opposed surfaces of two optical components, the method comprising the steps of providing at least one said surface with a thin layer of bonding glass having a glass transition temperature Tg substantially lower than the glass devitrification temperature Tc1, placing the said surfaces together with only the coating or coatings therebetween to form an assembly, and heating the assembly under pressure to a temperature Tb which lies between Tg and Tc1 and is sufficiently high to soften the glass and bond the components together. It may be desirable to provide the outer surface of one of the components so joined with a shaped layer of optical glass by the method of the present invention, and in such a case it would be convenient, but not strictly necessary, to use the same optical glass material both for the purpose of joining the components and for providing the shaped layer. In a particularly preferred method, a first of the components, which is to be provided with the external layer, is initially coated on both surfaces. Subsequently, it is brought into contact with the other substrate, which may or may not be coated on its adjacent surface, and the assembly is subject to heat and pressure as the external glass layer is embossed, while simultaneously the two components are joined together via the intermediate glass layer(s). Naturally the process could be extended to the provision of an assembly where both external surfaces are simultaneously provided with shaped or embossed surfaces, while joining the components.

The layers on the first component, or on both components, may have equal thicknesses. However, the requirements for bonding and shaping are likely to lead to unequal thicknesses, and in particular to the layer for shaping to be the thicker of the two.

In an alternative method, components joined by the method of our aforesaid copending UK Patent Application No. GB 0123731.2 are provided with a shaped glass layer by a method according to the present invention before or after the joining step. This may be accomplished by the use of the same glass material for both steps, but preferably the initial process (whether joining or shaping) is accomplished using a higher temperature than the second process, and in such a case it may be appropriate to use different glasses for the two layers, in conformity with the different temperature requirements. Thus a final glass deposition and embossing process applied to an assembly of components may use a glass having a lower first glass transition point Tg.

Our copending UK Patent Applications Nos. GB 123740.3 and GB 123742.9 relate to the provision of optical assemblies in which non-linear layers are bonded together preferably using a chalcogenide glass. The anti-reflection coating of the present invention may be applied to the exterior surface of any such assembly, and particularly but not exclusively where the same glass is used for the anti-reflection coating as is used for bonding.

The present invention extends to an optical substrate provided with a thin glass layer having a surface relief pattern formed in its external surface, such as may be produced by a method according to the invention as herein defined, and to optical arrangements comprising such a substrate.

Further details and advantages of the invention will be come apparent to the reader upon a perusal of the appended claims, to which the reader is referred.

1. A method of providing an optical substrate with a surface having a desired shape, the method comprising the steps of coating the surface with a thin layer of an optical glass, and subsequently modifying the shape of the external surface of the layer.

2. A method according to claim 1 wherein the temperature of the substrate surface is maintained at substantially less than 400° C.

3. (Cancelled)

4. A method according to claim 1 wherein the substrate and the optical glass are optically transmissive in the near infra-red and/or mid infra-red ranges.

5. A method according to claim 1 wherein refractive index of the optical glass is within 20% of the refractive index of the material providing the surface to be coated.

6. A method according to claim 1 wherein the modifying step includes polishing the glass layer to optical standards.

7. A method according to claim 6 wherein the final shape of the external coating surface conforms substantially to the general shape of the underlying substrate surface.

8. A method according to claim 1 wherein the shape modifying step provides detail across the glass layer.

9. A method according to claim 8 wherein said detail provides a “moth-eye” antireflection coating.

10. A method according to claim 8 wherein said detail provides a diffractive or interference structure.

11. (Cancelled)

12. (Cancelled)

13. A method according to claim 1 wherein the shape modifying step is effected by etching.

14. A method according to claim 1 wherein the shape modifying step is effected by embossing.

15. A method according to claim 1 wherein the shape modifying step is effected by use of a mask.

16. A method according to claim 1 wherein the optical glass has at least a first glass transition temperature Tg, and a higher devitrification temperature Tc, and the shaping is performed by embossing at a temperature Tg and Tc.

17. A method according to claim 16 wherein Te is selected so that the surface is substantially in its original state upon completion of the shape modifying step and cooling.

18. A method according to claim 16 wherein the optical glass has only one glass transition temperature before the devitrification temperature is reached.

19. A method according to claim 16 wherein the optical glass exhibits a plurality of glass transition temperatures, and Te is selected to lie between the first and second glass transition temperatures.

20. (Cancelled)

21. (Cancelled)

22. A method according to claim 1 wherein the thickness of the coating in the coating step is between 3 and 40 microns.

23. A method according to claim 1 wherein the optical glass is selected from a chalcogenide glass and amorphous arsenic sulphide.

24. (Cancelled)

25. (Cancelled)

26. A method of forming an assembly of two optical substrates with an external surface having a desired shape, the method comprising the steps of joining opposed surfaces of said substrates by providing at least one said surface with a thin layer of bonding glass having a glass transition temperature Tg substantially lower than the glass devitrification temperature Tc1, placing the said surfaces together with only the coating or coatings therebetween to form an assembly, and heating the assembly under pressure to a temperature Tb which lies between Tg and Tc1 and is sufficiently high to soften the glass and bond the components together, said method additionally performing the method as claimed in claim 1 for providing a external surface of a said substrate with a surface having a desired shape.

27. A method according to claim 25 wherein the joining and providing methods are performed simultaneously.

28. A method according to claim 25 wherein the joining and providing methods are performed sequentially in either order.

29. A method according to claim 26 wherein the bonding glass and the optical glass are of the same material.

30-46. (Cancelled)

47. A method according to claim 1 wherein said modifying is performed so that the thickness of at least one local area of the coated layer is reduced to an intermediate non-zero thickness.

48. A method according to claim 3 wherein said temperature is lower than 350° C.
